(19) United States
(12) Patent Application Publication
(10) Pub. No.: US 2026/0291879 A1
(43) Pub. Date: Sep. 24, 2026

(54) COMMUNICATION CONTROL SYSTEM

(71) Applicant: TOYOTA JIDOSHA KABUSHIKI KAISHA, Toyota-shi (JP)

(72) Inventor: Tsuneo NAKATA, Kamakura-shi (JP)

(73) Assignee: TOYOTA JIDOSHA KABUSHIKI KAISHA, Toyota-shi (JP)

(21) Appl. No.: 19/447,158

(22) Filed: Jan. 13, 2026

(30) Foreign Application Priority Data
Mar. 19, 2025 (JP) 2025-045290

(51) Int. Cl. H04L 47/43; H04L 12/14; H04L 47/32

(52) U.S. Cl. CPC H04L 47/43; H04L 12/14; H04L 47/32; H04L 2212/00

(57) ABSTRACT

In a communication control system, an information processing terminal transmits, when a communication link for performing the encapsulated communication is newly connected or a state of the communication link that is connected is changed, link information on the connected or state-changed communication link to the gateway server, assigns connection destination information on a connection destination of the packet received from an application to encapsulate the packet, and transmits the packet that is encapsulated to the gateway server via the communication link, and the gateway server identifies a charging mode of the communication link based on the link information received from the information processing terminal, identifies a connection destination of the packet that is received based on the connection destination information received from the information processing terminal, and aggregates a communication volume of the packet received from the information processing terminal for each of the connection destination and the charging mode.

### CROSS-REFERENCE TO RELATED APPLICATION

This application claims priority to Japanese Patent Application No. 2025-045290 filed on Mar. 19, 2025. The disclosure of the above-identified application, including the specification, drawings, and claims, is incorporated by reference herein in its entirety.

### BACKGROUND

### 1. Technical Field

The present disclosure relates to a communication control system.

### 2. Description of Related Art

Japanese Unexamined Patent Application Publication No. 2020-099097 (JP 2020-099097 A) discloses a technology that enables a communication service corresponding to a network that is a connection destination of a terminal.

### SUMMARY

In order to perform charging in accordance with a node or a service to which a connection is made, a connection destination of each packet needs to be determined. The determination can be made, for example, by using DNS spoofing. However, in a configuration in which multiple WANs connected to the Internet are provided, implementation may not be possible.

For example, when a terminal connects to a wireless LAN, name resolution is performed via a predetermined WAN. In this case, a data center cannot have information for associating the header information of the packet with the connection destination. When the terminal switches the connection from the wireless LAN to the cellular line, the data center cannot know the connection destination of the packet to be charged. As a result, the data center cannot aggregate the communication volume for each connection destination, and cannot perform charging according to the connection destination.

The present disclosure has been made in view of the above description, and an object of the present disclosure is to provide a communication control system capable of accurately charging in accordance with a connection destination.

A communication control system according to the present disclosure controls encapsulated communication in which a packet is encapsulated and communicated between an information processing terminal and a gateway server, the communication control system including:

the information processing terminal; and

the gateway server,

in which: the information processing terminal includes a first processor configured to

transmit, when a communication link for performing the encapsulated communication is newly connected or when a state of the communication link that is connected is changed, link information on the communication link that is connected or has a changed state to the gateway server,

assign connection destination information on a connection destination of the packet received from an application and encapsulate the packet, and

transmit the packet that is encapsulated to the gateway server via the communication link; and

the gateway server includes a second processor configured to

identify a charging mode of the communication link based on the link information received from the information processing terminal,

identify a connection destination of the packet that is received based on the connection destination information received from the information processing terminal, and

aggregate a communication volume of the packet received from the information processing terminal for each of the connection destinations and for each of the charging modes.

In the communication control system according to the present disclosure, the second processor is configured to aggregate the communication volume of the packet received from the information processing terminal for each of the connection destinations or groups of connection destinations, and for each of the charging modes.

In the communication control system according to the present disclosure, the first processor is configured to identify the connection destination of the packet by using a Domain Name System proxy.

In the communication control system according to the present disclosure, the first processor is configured to, when determination is made that the connection destination is not able to be identified, discard the packet received from the application or transmit the packet received from the application to the gateway server via the communication link that is free-of-charge.

In the communication control system according to the present disclosure, the first processor is configured to, when determination is made that the connection destination has been successfully identified, assign the connection destination information to the packet received from the application and encapsulate the packet.

According to the present disclosure, a communication control system capable of accurately charging according to a connection destination can be implemented.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a communication control system according to an embodiment;

FIG. 2 is a timing chart showing a usage example of a communication link;

FIG. 3 is a flowchart showing processing executed by a DCM;

FIG. 4 is a flowchart showing processing executed by a gateway server;

FIG. 5 is a flowchart showing processing executed by the DCM;

FIG. 6 is a diagram showing a configuration of an encapsulated packet;

FIG. 7 is a flowchart showing processing executed by the gateway server; and

FIG. 8 is a diagram showing a configuration of the encapsulated packet.

### DETAILED DESCRIPTION OF EMBODIMENTS

The communication control system according to the embodiment of the present disclosure will be described with reference to the drawings. Components in the following embodiments include components that can be replaced and easily implemented by those skilled in the art or substantially the same components.

### EMBODIMENT

### Communication System

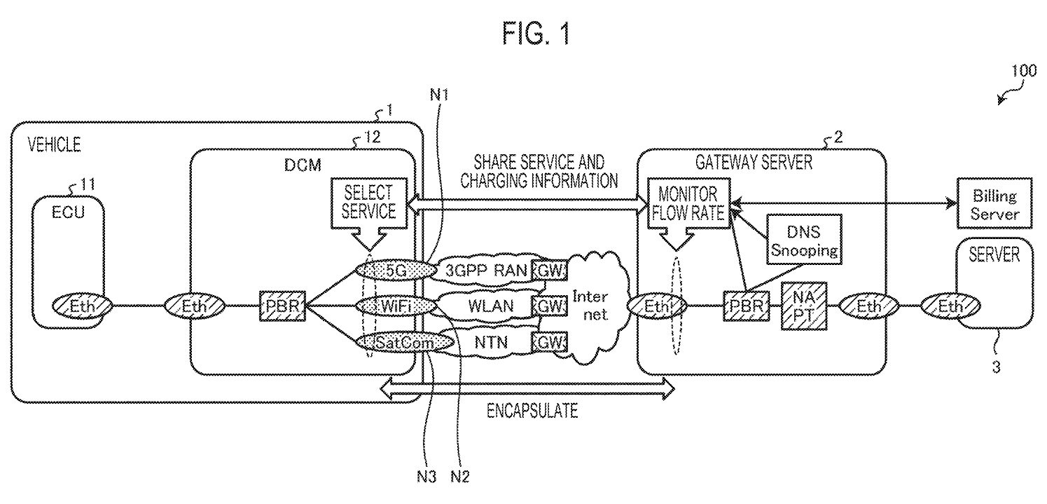

FIG. 1 is a schematic configuration diagram of a communication control system according to an embodiment. A communication control system 100 shown in FIG. 1 includes a vehicle 1, a gateway server 2, and a server 3. The vehicle 1 includes an electronic control unit (ECU) 11 and a data communication module (DCM) 12 as an information processing terminal. In the following description, an example will be described in which the vehicle 1 includes the ECU 11 and the DCM 12, but the ECU 11 may have functions of the DCM 12.

The communication control system 100 controls encapsulated communication in which a packet is encapsulated and communicated between the DCM 12 and the gateway server 2. Here, an example will be described in which the communication control system 100 controls the communication between the DCM 12 and the gateway server 2, but the present disclosure is not limited to the example. The communication control system 100 can be used to control communication between various terminals and the gateway server, such as communication between a personal computer or a smartphone and the gateway server.

Both the DCM 12 and the gateway server 2 are configured to have a communication function, to communicate with each other through a network, and to exchange various types of information. The network is configured by, for example, a communication link such as an Internet line network, a public line network such as a mobile phone line (cellular line) network, wireless communication such as Wi-Fi (registered trademark, Wireless Fidelity) and Bluetooth (registered trademark) Low Energy (BLE), and a satellite communication line through which communication is performed via a satellite.

In FIG. 1, an example is shown in which a 5G line N1 of a mobile phone line, a Wi-Fi line N2 of wireless communication, and a SatCom line N3 of satellite communication (SatCom) are connected as a communication link between the DCM 12 and the gateway server 2. The 5G line N1 is connected to the Internet by, for example, a radio access network (RAN) standardized by 3rd Generation Partnership Project (3GPP) (registered trademark). The Wi-Fi line N2 is connected to the Internet by, for example, a wireless LAN (WLAN). The SatCom line N3 is connected to the Internet by, for example, a non-terrestrial network (NTN).

The ECU 11 mainly includes a microcomputer including a processor consisting of, for example, a central processing unit (CPU) and the like, and a memory consisting of a read only memory (ROM), a random access memory (RAM), and the like. Various applications are installed in the ECU 11. The ECU 11 and the DCM 12 are connected by wire according to an Ethernet (registered trademark, Ethernet) standard.

The DCM 12 mainly includes a microcomputer including a first processor consisting of, for example, a CPU and the like, and a memory consisting of a ROM, a RAM, and the like. The DCM 12 transmits data received from an application of the ECU 11 to the gateway server 2 via a communication link selected by policy-based routing (PBR).

The gateway server 2 is implemented by, for example, a general-purpose computer such as a workstation or a personal computer including a second processor consisting of, for example, a CPU and the like, and a memory consisting of a ROM, a RAM, and the like. The gateway server 2 distributes and transmits the data received from the DCM 12 to the connection destination by PBR and network address port translation (NAPT). The connection destination is a predetermined node or a predetermined service designated by the application. In addition, the gateway server 2 monitors a flow of data while snooping on a DNS of the data received from the DCM 12, and aggregates a communication volume of the received data for each of the connection destination and the charging mode. The gateway server 2 and the server 3 are connected by wire according to the Ethernet standard.

The server 3 is implemented by, for example, a general-purpose computer such as a workstation or a personal computer including a processor consisting of, for example, a CPU and the like, and a memory consisting of a ROM, a RAM, and the like. The server 3 is a billing server for the application, acquires the communication volume and the charging mode of the data transmitted from the gateway server 2 to the server 3 from the gateway server 2, and performs billing based on the acquired information.

### Processing of Communication Control System

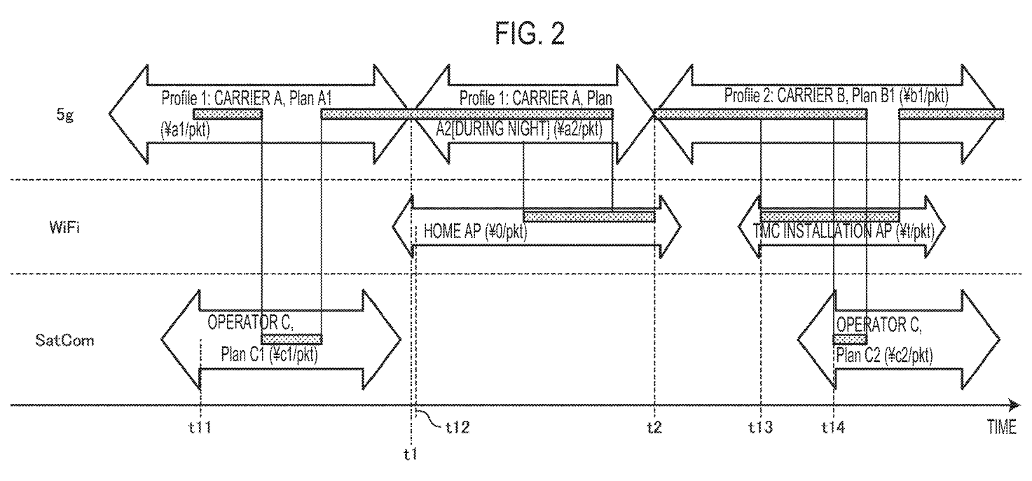

FIG. 2 is a timing chart showing a usage example of a communication link. A horizontal axis of FIG. 2 is a time axis, and the DCM 12 switches the communication link to be used from the 5G line N1, the Wi-Fi line N2, and the SatCom line N3 as time elapses, and transmits the encapsulated packet received from the application to the gateway server 2. In time t1 and t2, the charging mode of the 5G line N1 is changed. In addition, in time t11, t12, t13, and t14, the Wi-Fi line N2 or the SatCom line N3 is connected as a new communication link. As described above, in a case of changing the charging mode or connecting a new line, the DCM 12 is required to transmit the changed charging mode or the charging mode of the new communication link to the server 3.

### Processing of Notifying Charging Mode

Next, processing of the DCM 12 notifying the gateway server 2 of the charging mode will be described. Since the charging mode is changed when the communication link is newly connected or the state of the connected communication link is changed, the DCM 12 needs to notify the charging mode to the gateway server 2.

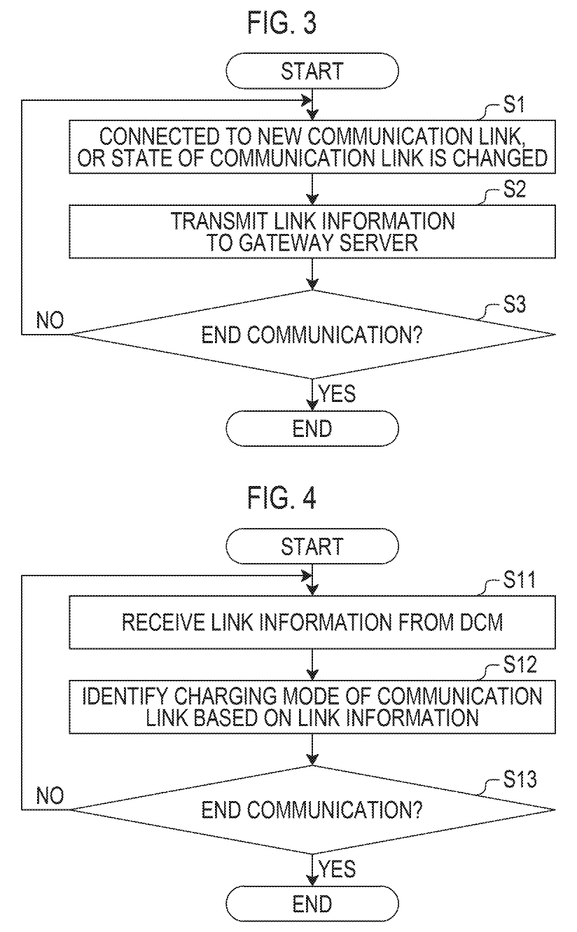

FIG. 3 is a flowchart showing processing executed by the DCM. As shown in FIG. 3, the DCM 12 detects that the communication link for performing the encapsulated communication is newly connected or the state of the connected communication link is changed (S1).

Subsequently, when the DCM 12 detects the connection or the state change of the communication link, the DCM 12 transmits the link information on the connected or state-changed communication link to the gateway server 2 (S2).

Thereafter, the DCM 12 determines whether a predetermined instruction input to instruct the end of the communication is made (S3). When the DCM 12 determines that the predetermined instruction input is made (S3: Yes), the series of processing ends.

On the other hand, when the DCM 12 determines that the predetermined instruction input is not made (S3: No), the processing returns to S1 and is continued.

The DCM 12 can transmit the link information of the latest communication link to the gateway server 2 by executing the processing of S1 to S3 at a predetermined cycle.

FIG. 4 is a flowchart showing processing executed by the gateway server. As shown in FIG. 4, the gateway server 2 receives the link information from the DCM 12 (S11).

Subsequently, the gateway server 2 identifies the charging mode of the communication link based on the received link information (S12).

Thereafter, the gateway server 2 determines whether a predetermined instruction input for instructing the end of the communication is made (S13). When the gateway server 2 determines that the predetermined instruction input is made (S13: Yes), the series of processing ends.

On the other hand, when the gateway server 2 determines that the predetermined instruction input is not made (S13: No), the processing returns to S11 and is continued.

When the link information is received, the gateway server 2 executes the processing of S11 to S13. As a result, the gateway server 2 can understand the charging mode of the latest communication link.

### Processing in Packet Transmission

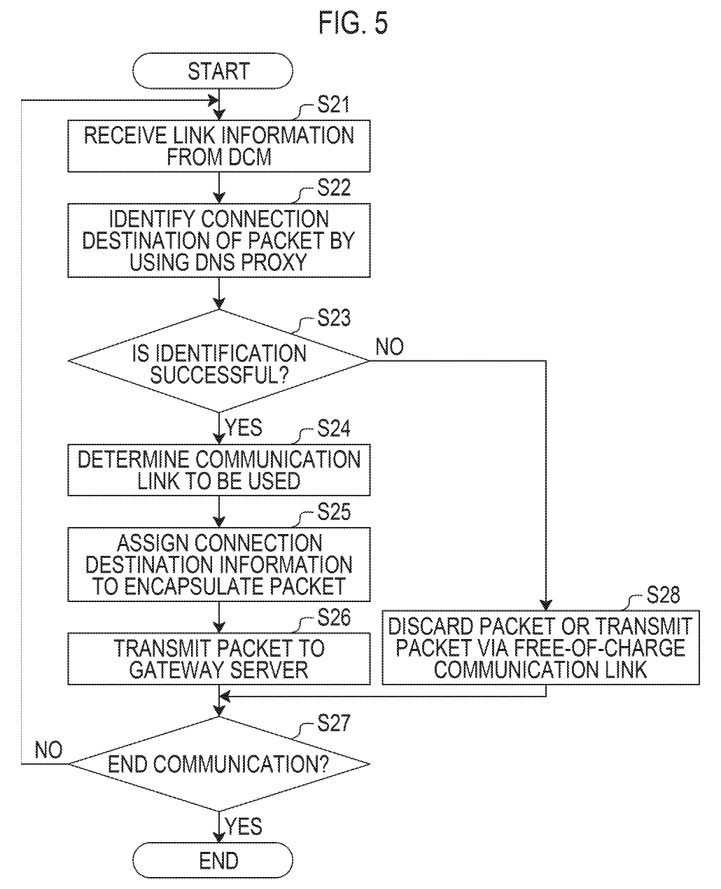

Next, processing of transmitting the packet transmitted by the application to the server 3 via the DCM 12 and the gateway server 2 will be described. FIG. 5 is a flowchart showing processing executed by the DCM. As shown in FIG. 5, the DCM 12 receives the packet from the application installed in the ECU 11 (S21).

Subsequently, the DCM 12 identifies the connection destination of the packet by using a domain name system (DNS) proxy (S22).

Further, the DCM 12 determines whether the connection destination has been successfully identified (S23). When the DCM 12 determines that the connection destination has been successfully identified (S23: Yes), the DCM 12 determines the communication link to be used (S24).

Then, the DCM 12 assigns the connection destination information on the connection destination of the packet received from the application to encapsulate the packet (S25).

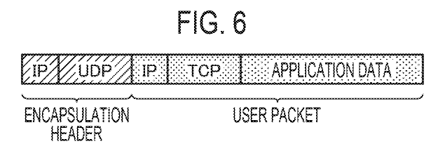

FIG. 6 is a diagram showing a configuration of the encapsulated packet. As shown in FIG. 6, the DCM 12 assigns an encapsulation header to the outside of a user packet including an IP packet, a transmission control protocol (TCP) packet, and a packet of application data. The encapsulation header includes an IP packet and a user datagram protocol (UDP) packet, and the DCM 12 uses a source port corresponding to a connection destination of the UDP.

Then, the DCM 12 transmits the encapsulated packet to the gateway server 2 via the determined communication link (S26).

Thereafter, the DCM 12 determines whether a predetermined instruction input for instructing the end of the communication is made (S27). When the DCM 12 determines that the predetermined instruction input is made (S27: Yes), the series of processing ends.

On the other hand, when the DCM 12 determines that the predetermined instruction input is not made (S27: No), the processing returns to S21 and is continued.

In S23, when the DCM 12 determines that the connection destination cannot be identified (S23: No), the DCM 12 discards the packet received from the application or transmits the packet to the gateway server via a free-of-charge communication link (S28).

When the packet is received from the application, the DCM 12 executes the processing of S21 to S28. As a result, the DCM 12 can assign the connection destination information to the packet received from the application to encapsulate the packet and transmit the encapsulated packet to the gateway server 2.

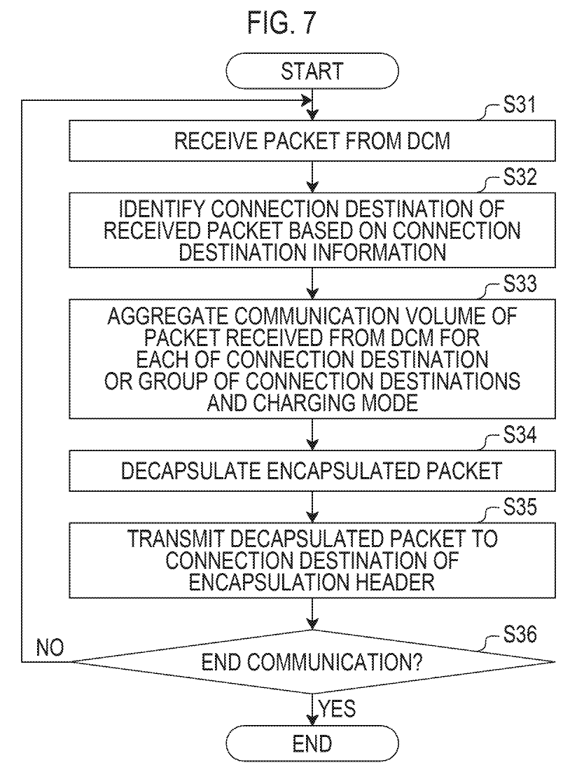

FIG. 7 is a flowchart showing processing executed by the gateway server. As shown in FIG. 7, the gateway server 2 receives the encapsulated packet from the DCM 12 (S31).

Subsequently, the gateway server 2 identifies the connection destination of the received packet based on the connection destination information received from the DCM 12 (S32).

Further, the gateway server 2 aggregates the communication volume of the packet received from the DCM 12 for each of the connection destination and the charging mode (S33).

Then, the gateway server 2 decapsulates the encapsulated packet (S34).

Further, the gateway server 2 transmits the decapsulated packet to the connection destination of the encapsulation header (S35).

Thereafter, the gateway server 2 determines whether a predetermined instruction input to instruct the end of the communication is made (S36). When the gateway server 2 determines that the predetermined instruction input is made (S36: Yes), the series of processing ends.

On the other hand, when the gateway server 2 determines that the predetermined instruction input is not made (S36: No), the processing returns to S31 and is continued.

When the packet is received from the DCM 12, the gateway server 2 executes the processing of S31 to S36. As a result, the gateway server 2 can aggregate the communication volume of the packet received from the DCM 12 for each of the connection destination and the charging mode, and transmit the communication volume to the server 3 of the connection destination.

According to the embodiment described above, the DCM 12 assigns the connection destination information to the packet received from the application to encapsulate the packet, and the gateway server 2 aggregates the communication volume of the packet for each of the connection destination and the charging mode. As a result, the communication control system 100 can accurately charge in accordance with the connection destination.

### Modification

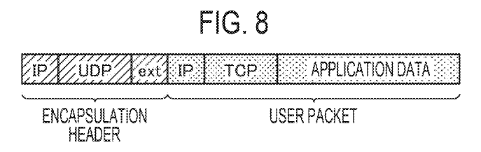

FIG. 8 is a diagram showing a configuration of the encapsulated packet. As shown in FIG. 8, the DCM 12 assigns an encapsulation header to the outside of a user packet including an IP packet, a TCP packet, and a packet of application data. The encapsulation header includes an IP packet, a UDP packet, and an extra (ext) packet, and the DCM 12 writes a connection destination ID corresponding to the connection destination into the ext packet. In this case, even a connection destination ID that is too long to fit in a source code can be written.

In the embodiment, the example has been described in which the DCM 12 identifies the connection destination of the packet by using the DNS proxy, but the present disclosure is not limited to the example. The DCM 12 may capture the DNS communication of an app client and determine the connection destination from the content thereof. In addition, the DCM 12 may determine the connection destination by using the DNS proxy on a gateway server 2 side. In addition, the DCM 12 may encapsulate the DNS communication of the app client, and the gateway server 2 may capture the DNS communication and determine the connection destination from the content thereof.

In addition, in the embodiment, the example has been described in which the DCM 12 uses the source port corresponding to the connection destination of the UDP of the encapsulation header, but the present disclosure is not limited to the example. The DCM 12 may perform encapsulation by TCP/IP tunneling and define the connection destination ID field as an option field of the TCP. In addition, the DCM 12 may perform encapsulation by a tunneling protocol including an IP header, such as ipinip, UDP/IP, TCP/IP, and GRE, and define the ID field of the connection destination in an option field of the IP header.

In addition, the connection destination is not limited to a single node, and may be a group including a plurality of nodes. In this case, the gateway server 2 aggregates the communication volume of the packet received from the DCM 12 for each of the connection destination or the group of the connection destinations and the charging mode.

Further effects and modifications can be easily derived by those skilled in the art. Therefore, a broader aspect of the present disclosure is represented and described as described above, and is not limited to the specific details and representative embodiments described above. Accordingly, various changes can be made without departing from the spirit or scope of the general inventive concept defined by the appended claims and equivalent thereof.

What is claimed is:

1. A communication control system that controls encapsulated communication in which a packet is encapsulated and communicated between an information processing terminal and a gateway server, the communication control system comprising:
the information processing terminal; and
the gateway server, wherein:
the information processing terminal includes a first processor configured to
transmit, when a communication link for performing the encapsulated communication is newly connected or when a state of the communication link that is connected is changed, link information on the communication link that is connected or has a changed state to the gateway server,
assign connection destination information on a connection destination of the packet received from an application to the packet and encapsulate the packet, and
transmit the packet that is encapsulated to the gateway server via the communication link; and
the gateway server includes a second processor configured to
identify a charging mode of the communication link based on the link information received from the information processing terminal,
identify the connection destination of the packet that is received based on the connection destination information received from the information processing terminal, and
aggregate a communication volume of the packet received from the information processing terminal for each of the connection destinations and for each of the charging modes.

2. The communication control system according to claim 1, wherein the second processor is configured to aggregate the communication volume of the packet received from the information processing terminal for each of the connection destinations or groups of connection destinations, and for each of the charging modes.

3. The communication control system according to claim 1, wherein the first processor is configured to identify the connection destination of the packet by using a Domain Name System proxy.

4. The communication control system according to claim 1, wherein the first processor is configured to, when determination is made that the connection destination is not able to be identified, discard the packet received from the application or transmit the packet received from the application to the gateway server via the communication link that is free-of-charge.

5. The communication control system according to claim 1, wherein the first processor is configured to, when determination is made that the connection destination has been successfully identified, assign the connection destination information to the packet received from the application and encapsulate the packet.
